(19) United States
(12) Patent Application Publication
(10) Pub. No.: US 2024/0065300 A1
(43) Pub. Date: Feb. 29, 2024

(54) FREEZE DRIED, READY TO CONSUME FOOD PRODUCTS AND PROCESSES FOR THEIR PREPARATION

(71) Applicant: VITALMELT LTD., Petan Tikva (IL)

(72) Inventor: David KLIGER, Ramat Gan (IL)

(21) Appl. No.: 18/271,662

(22) PCT Filed: Feb. 2, 2022
(86) PCT No.: PCT/IL2022/050140

§ 371 Date: Jul. 10, 2023

Related U.S. Application Data
(60) Provisional application No. 63/145,618, filed on Feb. 4, 2021.

(51) Int. Cl. A23L 3/44; A23L 33/105; A23L 33/115; A23L 33/15

(52) U.S. Cl. CPC A23L 3/44; A23L 33/105; A23L 33/115; A23L 33/15

(57) ABSTRACT

Provided herein are freeze-dried nutraceutical compositions including a mixture of at least 10% w/w of a fruit and/or vegetable puree; at least 5% w/w of an edible oil; and at least 0.05% w/w of an exogenous nutraceutical; wherein the freeze-dried nutraceutical composition melts in the mouth.

### TECHNOLOGICAL FIELD

The present invention provides a freeze-dried solid nutraceutical composition in a product form that instantly melts in the mouth, processes for its preparation as well as use of same for subject in the need thereof, such as, but not limited to, bariatric patients.

### BACKGROUND

Nutraceuticals are a group of products that are more than food but less than pharmaceuticals. In most countries, nutraceuticals are taken as part of dietary supplements. Frequency of nutraceuticals use is 50%-70% in developed countries' population and this number is increasing by the age and at times may be prescribed due to nutritional deficiencies.

For example, because bariatric surgery often involves gut manipulation that alters the natural absorption of nutrients, nutritional deficiencies can develop. As more than 250,000 people in the United States alone had bariatric surgery, nutritional deficiencies has become a more and more acute problem.

The most common deficiencies are vitamin B₁₂, folate, zinc, iron, copper, calcium, and vitamin D and can lead to secondary problems, such as osteoporosis, Wernicke encephalopathy, anemia, and peripheral neuropathy.

Accordingly, to avoid nutritional deficiency, dietary supplements are often prescribed shortly after surgery. Because most programs advise against swallowing pills whole, patients typically need to crush, crumble, or split pills, or take supplements in chewable, liquid or powdered form, often having unpleasant taste. Lack of compliance has accordingly led to more than 50% of patients having iron deficiency, while nearly 30% suffer from cobalamin deficiency.

Accordingly, there is a need for improved nutraceutical composition, which can provide various nutraceuticals in a cost effective dosage from which need not be swallowed and which have a flavor encouraging compliance.

### SUMMARY

According to some embodiments, provided herein are advantageous freeze-dried solid nutraceutical composition in a product form that can instantly melt in the mouth of a subject, wherein the nutraceutical composition includes fruit and/or vegetable puree, edible oil and at least one exogenously added nutraceutical, wherein after mixing such components, the composition is freeze dried, to the ready to be consumed nutraceutical composition product. In some embodiments, the present invention provides a nutraceutical product/composition which includes: at least 10% w/w of a fruit puree; at least 5% w/w of an edible oil; and at least 0.05% w/w of an exogenously added nutraceutical (or combination of nutraceuticals); wherein the nutraceutical composition is freeze dried into a ready to be consumed product form which is capable of melting in the mouth.

Advantageously, as exemplified herein, the components of the nutraceutical product maintain at least 75%, even at least 90% and even at least 95% of their initial nutritional value (i.e., prior to freeze drying).

As a further advantage, as further exemplified herein, the nutraceutical product is devoid of un-natural preservatives and all ingredients thereof are 100% natural.

According to some embodiments, advantageously, the ready to consume nutraceutical product disclosed herein have a good taste, which encourage compliance when such is prescribed/desired.

According to some embodiments, due to the product being capable of melting in the mouth, the herein disclosed compositions may be used/consumed by a wide range of subjects, including, healthy subjects, and subjects afflicted with a disease or condition, in particular, conditions which affect appetite, eating or swallowing. In some embodiments, the herein disclosed compositions are particularly useful for administration to subject's having trouble swallowing, such as for example, but not limited to bariatric patient.

According to some embodiments, there are provided herein advantageous nutraceutical compositions, which are ready for oral consumption, cost efficient and effective in providing various nutraceutical remedies to subjects in need thereof, by preventing and/or improving health condition of subjects (users). In some embodiments, the compositions disclosed herein are advantageous, as they exhibit improved bioavailability of exogenous nutraceutical substances included within the compositions, thereby facilitating an enhanced effect thereof.

According to some embodiments, there is provided a nutraceutical composition which includes a mixture of: (a) at least 10% w/w of a fruit and/or vegetable puree; (b) at least 5% w/w of an edible oil; and (c) at least 0.05% w/w of an exogenous nutraceutical (which can include one or more nutraceuticals), or of a mixture which of a nutraceutical and a corresponding thickening agent.

According to some embodiments, the nutraceutical composition is freeze dried to obtain a ready to be consumed product form, which is capable of melting in the mouth.

According to some embodiments, the composition includes less than 5% w/w water.

According to some embodiments, the composition includes at least 15%-70% w/w of the fruit and/or vegetable puree. In some embodiments, the composition includes at least 15%-70% w/w of fruit puree. the composition includes at least 15%-70% w/w of vegetable puree.

According to some embodiments, the composition includes 10%-40% w/w of the edible oil.

According to some embodiments, the composition includes at least 5% w/w of the exogenous nutraceutical. According to some embodiments, the composition includes at least 0.5% of the exogenous nutraceutical. According to some embodiments, the composition includes at least 0.05% of the exogenous nutraceutical.

According to some embodiments, the exogenous nutraceutical is a vitamin, a mineral, an herb, an herb extract, an herb derivative, a metabolite, a fungus, sprouts, wheat sprouts, lentil sprouts, barley sprouts, fenugreek sprouts, curcumin sprouts, mung bean or any combination thereof.

According to some embodiments, the exogenous nutraceutical is a vitamin. According to some embodiments, the composition may include at least 0.05% w/w of the vitamin and 15%-50% of fruit and/or vegetable puree. According to some embodiments, the vitamin is a multivitamin (i.e., a combination/mixture of various vitamins, as detailed herein).

According to some embodiments, the exogenous nutraceutical is a fungus. According to some embodiments, the composition may include at least 0.05% w/w, at least 0.5% w/w, or at least 5% w/w of the fungus and 15%-50% of fruit and/or vegetable puree. According to some embodiments, the fungus is a fungus of the Cordyceps species.

According to some embodiments, the exogenous nutraceutical is or includes CBD and/or THC. According to some embodiments, the composition comprises 0.1-2% w/w CBD and/or THC or 0.5-1% w/w CBD and/or THC and 30%-70% of fruit and/or vegetable puree.

According to some embodiments, the composition may include a flavoring agent.

According to some embodiments, the composition may include a sweetener. According to some embodiments, the composition may include at least about 15% w/w of the sweetener. According to some embodiments, the composition may include about 20%-40% w/w of the sweetener.

According to some embodiments, the edible oil is an oil having a melting temperature below 50° C. According to some embodiments, the edible oil is an oil having a melting temperature below 40° C. According to some embodiments, the edible oil is selected from a vegetable oil, a saturated fatty acid, unsaturated fatty acid, or any combinations thereof. According to some embodiments, the edible oil is coconut oil.

According to some embodiments, the composition may include about 1%-5% of water. According to some embodiments, the composition may include less than about 5% of water.

According to some embodiments, there is provided a process for the preparation of a freeze-dried nutraceutical composition, the process includes the steps of:
a. mixing a nutraceutical with an edible oil to obtain a first mixture, wherein the mixing is performed at a temperature of below 50° C.;
b. mixing the first mixture with a fruit and/or vegetable puree to obtain a second mixture;
c. freeze drying said second mixture until water content is less than about 5% w/w of the product; thereby producing a freeze-dried nutraceutical composition having a ready to be consumed product form, which melts in the mouth.

According to some embodiments, step (a) includes mixing at least 0.05% w/w of the final product of the exogenous nutraceutical with at least 5% w/w of the final product of the edible oil.

According to some embodiments, step (b) includes mixing the first mixture with at least 10% w/w of the final product of the fruit puree.

According to some embodiments, the method may further include adding a flavoring agent and/or a sweetener at step (a) and/or at step (b). According to some embodiments, the method may further include adding a flavoring agent and/or a sweetener at step (b). According to some embodiments, at least 15% w/w of the final product of sweetener is added.

According to some embodiments, the second mixture is casted into a mold prior to the freeze drying. According to some embodiments, the second mixture is frozen and shaped prior to freeze drying.

According to some embodiments, there is provided a process for the preparation of a freeze-dried nutraceutical composition, the process includes the steps of mixing an exogenous nutraceutical with a vegetable and/or fruit puree and edible oil, at a temperature of below about 50° C. and freeze drying said second mixture until water content is less than about 5% w/w of the product.

According to some embodiments, there is provided a method for administering a nutraceutical to a subject in need thereof, the method comprising inserting into the subject's mouth, the nutraceutical composition, as disclosed herein.

According to some embodiments, the subject is a subject undergoing or having undergone bariatric surgery.

According to some embodiments, there is provided nutraceutical composition, as essentially disclosed herein, for use in administration of a nutraceutical to a subject in need thereof.

According to some embodiments, the subject is a subject undergoing or having undergone bariatric surgery.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 is a flowchart of steps in a process of preparing a freeze dried nutraceutical product, according to some embodiments;

FIG. 2 is an illustrative photograph of a freeze-dried single dose composition comprising multivitamin, as disclosed herein;

FIG. 3 is an illustrative photograph of a freeze-dried single dose composition comprising CBD, as disclosed herein.

### DETAILED DESCRIPTION OF EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, there is provided a nutraceutical product/composition comprising: at least 10% w/w of a fruit and/or vegetable puree; at least 5% w/w of an edible oil; and at least 0.05% w/w of an exogenously added nutraceutical; wherein the nutraceutical composition is freeze dried into a ready to be consumed product form which melts in the mouth.

As used herein the terms “nutraceutical”, “exogenous nutraceutical” and “bioceutical” may be used interchangeably and refer to any substance (which can be consumed as a food or part of a food) and provides medical or health benefits, including the prevention and/or treatment of a condition or disease.

According to some embodiments, the nutraceutical may be a dietary supplement.

According to some embodiments, the nutraceutical may be or may include vitamins, minerals, herbs or other botanicals, such as sprouts (including, wheat sprouts, lentil sprouts, barley sprouts, fenugreek sprouts, curcumin sprouts, mung bean), amino acids, proteins, substances such as enzymes, organ tissues, glandular, metabolites, or any combination thereof. Each possibility is a separate embodiment

As a non-limiting example, the exogenous nutraceutical may be a vitamin, such as but not limited to a multivitamin (which includes a combination/mixture of vitamins and/or various minerals). According to some embodiments, the exogenous nutraceutical may include one or more of vitamin A (as all-trans-retinol, all-trans-retinyl-esters, as well as all-trans-beta-carotene and other provitamin A carotenoids), vitamin B₁ (thiamine (such as, Thiamine Hydrochloride), vitamin B₂ (riboflavin), vitamin B₃ (niacin), vitamin B₅ (pantothenic acid), vitamin B₆ (pyridoxine), vitamin B₇ (biotin), vitamin B₉ (folic acid or folate), vitamin B₁₂ (cobalamins (such as cyanocobalamin), vitamin C (ascorbic acid), vitamin D (calciferols (such as, D3)), vitamin E (tocopherols and tocotrienols (such as a-tocopherol acetate)), vitamin K (phylloquinone and menaquinones), Zinc, Magnesium (Mg in various forms), Calcium, Copper, Selenium and Iron. Each possibility is a separate embodiment.

Other non-limiting examples of nutraceutical include fungi, collagen, hyaluronic acid, caffeine, probiotics, probiotic bacteria, dietary fibers, dietary supplements, minerals, and the like. Each possibility is a separate embodiment.

According to some embodiments, the nutraceutical may be or include a fungus. According to some embodiments, the fungus may be a fungus of the Cordyceps species.

According to some embodiments, the nutraceutical may be an extracts or concentrate. As a non-limiting example, the nutraceutical may be an herb extract, such as cannabis extract. According to some embodiments, the nutraceutical may be a compound extracted from an herb such as a cannabinoid. According to some embodiments, the cannabinoid may be THC and/or CBD.

According to some embodiments, the composition may include about 0.0005% to about 40% w/w of the exogenous nutraceutical. According to some embodiments, the composition may include about 0.01% to about 38% w/w of the nutraceutical. According to some embodiments, the composition may include about 0.05% to about 35% w/w of the nutraceutical. According to some embodiments, the composition may include about 0.5% to about 35% w/w of the nutraceutical. According to some embodiments, the composition may include about 1% to about 30% w/w of the nutraceutical. According to some embodiments, the composition may include about 5% to about 30% w/w of the nutraceutical. According to some embodiments, the composition may include about 12% to about 25% w/w of the of the nutraceutical. According to some embodiments, the composition may include about 0.005% to about 8% w/w, or about 0.05% to about 7%, or about 0.5% to about 5% of the exogenous nutraceutical. According to some embodiments, the composition may include about 0.2% to about 2% w/w, or about 0.5% to about 1% of the of the exogenous nutraceutical. According to some embodiments, the composition may include at least 0.05%, at least 0.5%, at least 1%, at least 2%, at least 5%, at least 10%, or at least 15% w/w of the nutraceutical. According to some embodiments, the composition may include about 10%, about 15%, about 20%, about 25%, about 30% or about 40% w/w of the of the exogenous nutraceutical. Each possibility is a separate embodiment.

According to some embodiments, the amount of the exogenous nutraceutical in the composition depends on the type of the nutraceutical.

As a non-limited example, when the exogenous nutraceutical is a vitamin, the composition preferably includes at least 0.05%, at least 0.5%, at least 5%, at least 10%, or at least 15% w/w of the exogenous nutraceutical. In some embodiments, in which the vitamin is Vitamin D, at least 400 IU may be included in the composition. Each possibility is a separate embodiment.

As another non-limited example, when the exogenous nutraceutical is CBD (or other metabolite), the composition preferably includes less than 5%, less than 2% CBD, or less than 1% CBD w/w of the nutraceutical. Each possibility is a separate embodiment.

According to some embodiments, the nutraceutical may be in the form of a powder, a microcapsule, a liquid a softgel, or the like.

As used herein, the term “exogenously added” with regards to the nutraceutical refers to the nutraceutical as a separate component and not as a component of other ingredients of the composition. As a non-limiting example, the nutraceutical may be vitamin C in which case it refers to vitamin C added as a separate, exogenous component, different from the vitamin C of the fruit puree.

According to some embodiments, the term “fruit puree” may refer to any type of fruit or combination of fruits that has been cooked, ground, pressed, blended or sieved until it reaches a consistency of a creamy paste or liquid.

According to some embodiments, the composition includes about 15% to about 70% w/w of the fruit puree. According to some embodiments, the composition includes about 20% to about 60% w/w of the fruit puree. According to some embodiments, the composition includes at least 15%, or at least 20% w/w of the fruit puree. According to some embodiments, the composition includes about 20%, about 25%, about 28%, about 30%, about 35%, about 40%, w/w about 50% w/w or about 55% w/w of the fruit puree. Each possibility is a separate embodiment.

According to some embodiments, the amount of fruit puree in the composition depends on the type of the nutraceutical.

As a non-limited example, when the nutraceutical is a vitamin, the composition preferably includes about 15% w/w to about 50% w/w or about 20% w/w to about 40% w/w of the fruit puree. Each possibility is a separate embodiment.

As another non-limited example, when the nutraceutical is CBD (or other metabolite), the composition preferably includes about 25% w/w to about 75% w/w or about 20% w/w to about 60% w/w of the fruit puree. Each possibility is a separate embodiment.

According to some embodiments, the composition may in addition to, or as an alternative to the fruit puree include a vegetable puree. Thus in some embodiments, the composition may include a fruit puree and/or a vegetable puree.

According to some embodiments, the term “vegetable puree” may refer to any type of vegetable or combination of vegetables that has been cooked, ground, pressed, blended or sieved until it reaches a consistency of a creamy paste or liquid.

According to some embodiments, the composition may include about 15% to about 70% w/w of the vegetable puree. According to some embodiments, the composition may include about 20% to about 60% w/w of the vegetable puree. According to some embodiments, the composition may include at least 15%, or at least 20% w/w of the vegetable puree. According to some embodiments, the composition may include about 20%, about 25%, about 28%, about 30%, about 35%, about 40%, w/w about 50% w/w or about 55% w/w of the vegetable puree. Each possibility is a separate embodiment.

According to some embodiments, the amount of vegetable puree in the composition depends on the type of the exogenous nutraceutical.

As a non-limited example, when the exogenous nutraceutical is a vitamin, the composition preferably includes about 15% w/w to about 50% w/w or about 20% w/w to about 40% w/w of the vegetable puree. Each possibility is a separate embodiment.

As another non-limited example, when the exogenous nutraceutical is CBD (or other metabolite), the composition preferably includes about 25% w/w to about 75% w/w or about 20% w/w to about 60% w/w of the vegetable puree. Each possibility is a separate embodiment.

According to some embodiments, the composition is suitable for use as a food product. The term “food product” as used herein should be understood to encompass a product that is consumed to provide nutrition to a subject. The food product is in a solid form that is ready to be consumed by directly introducing to the mouth.

It is further defined that the composition of the present invention is “freeze-dried”, also known as “lyophilization” and “cryodesiccation” resulting in a chewable and/or meltable solid form. As used herein, “freeze drying” refers to a low temperature dehydration process that involves freezing the product, lowering pressure, followed by a removing of ice by sublimation. This is in contrast to dehydration by most conventional methods that evaporate water using heat.

Additionally, composition of the present invention is defined to be a “ready to be consumed product”, thus it does not have to be further prepared in any manner. It does not have to be cooked, rehydrated, steamed, mixed with a liquid (hot or cold), fried, microwaved or any other form of preparation.

As used herein, the term “edible oil” is fat of plant, animal or microbial origin. According to some embodiments, the edible oil is meltable at temperatures below 40° C., below 37° C., below 35° C., below 30° C. or at room temperature and is suitable for food use. Non-limiting examples of suitable oils include coconut oil, palm oil and palm kernel oil, soybean oil, canola oil (rapeseed oil), corn oil, peanut oil, sunflower oil, olive oil and other vegetable oils. Each possibility is a separate embodiment. According to some embodiments, the edible oil is coconut oil.

According to some embodiments, the composition may include about 10% to about 40% w/w of the edible oil. According to some embodiments, the composition includes about 15% to about 30% w/w of the edible oil. According to some embodiments, the composition includes at least 15%, or at least 20% w/w of the edible oil. According to some embodiments, the composition includes about 10%, about 15%, about 20%, about 25%, about 30% or about 40% w/w of the edible oil. Each possibility is a separate embodiment.

According to some embodiments, the composition has less than 5% w/w water. The term “less than 5% w/w of water” should be understood to relate to the amount of water present in the final food product of the invention. Since the food product of the invention is solid and chewable/meltable, the amount of hydration in the product to be consumed is reduced to less than 5% by weight of the product.

According to some embodiments, the composition has between about 1% to about 5% of water. In some embodiments, the composition has about 1%, 2%, 3%, 4%, 5% weight of the product of water. Each possibility is a separate embodiment.

According to some embodiments, the composition may further include a sweetener. According to some embodiments, the sweetener may be a natural sweetener. Non-limiting examples of suitable natural sweeteners include sugar, glucose, fructose, stevia, erythritol, Xylitol, Mannitol, Yacon syrup, honey, maple, molasses, coconut sugar, Monk fruit sweetener and any combination thereof. Each possibility is a separate embodiment. According to some embodiments, the sweetener may be a synthetic sweetener. Non-limiting examples of suitable natural sweeteners include aspartame, Acesulfame potassium, Advantame, Aspartame-acesulfame salt, Cyclamate, Neotame, Neohesperidin, Sacchari, Sucralose or any combination thereof. Each possibility is a separate embodiment.

According to some embodiments, the sweetener is white sugar.

According to some embodiments, the composition comprises at least about 10%, at least about 15%, at least about 20% or at least about 25% or at least about 30% w/w of the white sugar or other sweetener. Each possibility is a separate embodiment. According to some embodiments, the composition comprises about 10% to about 40% w/w of white sugar or other sweetener. According to some embodiments, the composition comprises about 15% to about 30% w/w of white sugar or other sweetener. According to some embodiments, the composition comprises about 10%, about 15%, about 20%, about 25% or about 30% w/w of white sugar or other sweetener. Each possibility is a separate embodiment.

In some embodiments, a food product of the invention may further include in addition to, or alternatively to the sweetener, at least one flavoring agent. It should be noted that said flavoring agent relates to any type of edible substance added to a product of the invention (at any step of product preparation) that adds and/or alters and/or intensifies the flavor of a product of the invention through the sense of taste and/or smell. In some embodiments said at least one flavoring agent is a natural flavoring substance (i.e. flavoring substances obtained from plant or animal raw materials, by physical, microbiological or enzymatic processes), a nature-identical flavoring substance (i.e. flavoring substances that are obtained by synthesis or isolated through chemical processes, which are chemically and organoleptically identical to flavoring substances naturally present in products intended for human consumption) or an artificial flavoring substance (i.e. chemically produced flavoring substances that are typically chemically different from the corresponding natural flavoring substance however, in sensory characteristics are the same as natural ones), and any combination thereof.

In some embodiments, said at least one flavoring agent is selected from the group consisting of a sweetening agent (such as a sweetening saccharide, sugar, sugar substitutes), fructose, galactose, flavoring extracts (such as spices and herb flavors, including vanilla, cinnamon, nutmeg, cardamom and so forth; fruit flavors including banana, strawberry, berry, grape, orange, pineapple, lemon and so forth) and any combinations thereof.

According to some embodiments, the food flavoring agent may be a spice or combination of spices, such as, but not limited to: salt, pepper, garlic (for example, in the form of powder), onion (for example, in the form of powder), and the like. According to some embodiments, the food flavoring agent may be an herb or combination of dried spice herbs, such as, but not limited to: oregano, basil, thyme, coriander, parsley, and the like.

According to some embodiments, the flavoring agent may be lemon salt.

According to some embodiments, the composition comprises at least about 0.1%, at least about 0.5%, at least about 1%, at least about 1.5% or at least about 2% w/w of lemon salt or other flavoring agent. Each possibility is a separate embodiment. According to some embodiments, the composition comprises about 0.5% to about 5% w/w of lemon salt or other flavoring agent. According to some embodiments, the composition comprises about 1%% to about 3% w/w of lemon salt or other flavoring agent. According to some embodiments, the composition comprises about 0.5%, about 1%, about 1.5%, about 2% or about 2.5% w/w of lemon salt or other flavoring agent. Each possibility is a separate embodiment.

According to some embodiments, the composition may further include a thickening component. In some embodiments, the at least one thickening component may be a monosaccharide, oligosaccharide (for example disaccharides, like sugar), polysaccharide (for example starch, which can be either native, none-native, modified or processed starch and any combinations thereof) or any combinations thereof. In other embodiments, the at least one thickening component is starch. In yet further embodiments, the at least one thickening component is a mixture of starch and sugar. In some embodiments, the at least one thickening component is starch selected from potato starch, tapioca starch, rice starch, corn starch, wheat starch, maze starch, cassava starch, sweet potato starch or any combinations thereof.

In some embodiments, the at least one thickening component may be between about 10% to about 70% weight of the product. In some embodiments, the at least one thickening component is about 10%, 20%, 25%, 30%, 35%, 40%, 45%, 50%, 55%, 60%, 65%, 70% weight of the product. Each possibility is a separate embodiment.

In some embodiments, a food product of the invention has a mechanical compressibility of at least 5N/cm²/or Pa″¹. In some embodiments, a food product of the invention has a mechanical compressibility in the range of between 5 N/cm² and 20 N/cm².

In some embodiments, a food product of the invention has a density of at least 120 mg/cm³. In some embodiments, a food product of the invention has a density in the range of between 120 mg/cm³ and 500 mg/cm³.

In some embodiments, the composition is a non-dairy food product, thus it does not contain any dairy component. Alternatively, the composition may further include at least one dairy component.

According to some embodiments, the composition further includes a natural preservative, an oxidating agent, an emulsifier or other food grade agent optimizing the structure, chewability, meltability, preservation or other feature/characteristic of the composition.

The term “a” and “an” refers to one or to more than one (i.e., to at least one) of the grammatical object of the article. By way of example, “an element” means one element or more than one element.

The term “about” when referring to a measurable value such as an amount, a temporal duration, and the like, is meant to encompass variations of ±20% or in some instances ±10%, or in some instances ±5%, or in some instances ±1%, or in some instances ±0.1% from the specified value, as such variations are appropriate to perform the disclosed methods.

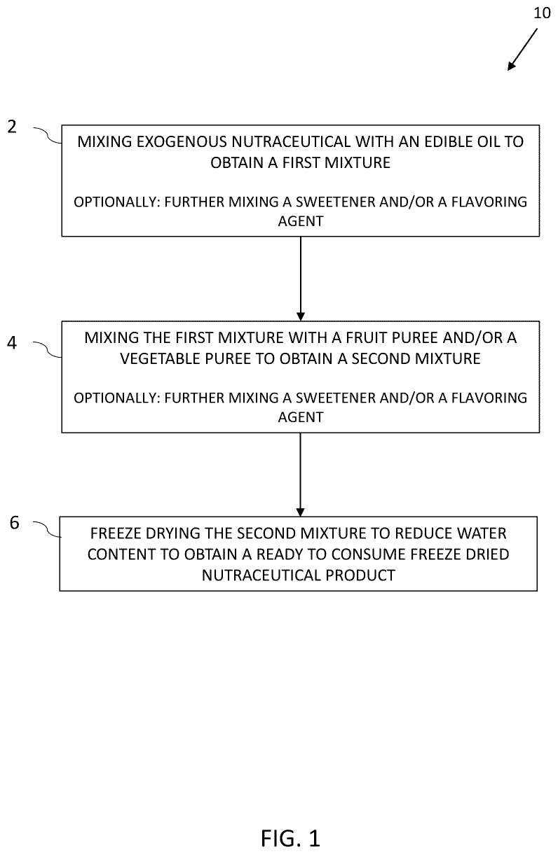

According to some embodiments, there is provided a process for the preparation of a freeze-dried nutraceutical composition as disclosed herein. Reference is now made to FIG. 1 which shows steps in the preparation process. As shown in FIG. 1, process 10 includes at Step 2, mixing of an exogenous nutraceutical is mixed with an edible oil to obtain a first mixture. Step 2 may be performed at a temperature of below about 50° C., below about 40° C., below about 30° C. Step 2 may optionally further include mixing a sweetener and/or a flavoring agent in the first mixture. At Step 4, the first mixture obtained in Step 2 is mixed with a selected fruit puree and/or vegetable puree to obtain a second mixture. Step 4 may optionally further include mixing a sweetener and/or a flavoring agent with the second mixture. At step 6, the second mixture obtained in Step 4 is freeze dried under suitable conditions, until water content is reduced to less than about 5% w/w of the final ready to consume nutraceutical product.

According to some embodiments, there is further provided a process for the preparation of a freeze-dried nutraceutical composition, the process includes the steps of:
a. mixing a nutraceutical with an edible oil to obtain a first mixture, wherein the mixing is performed at a temperature of below about 50° C.;
b. mixing the first mixture with a fruit and/or vegetable puree to obtain a second mixture;
c. freeze drying the second mixture until water content is less than 5% w/w of the product; thereby producing a freeze-dried nutraceutical composition having a ready to be consumed product form, which melts in the mouth.

According to some embodiments, step (a) includes mixing at least 0.05% w/w nutraceutical, or at least 0.5% w/w nutraceutical with at least 5%, at least 10% w/w of the edible oil, wherein the weight percent relates to the total weight of the final product.

According to some embodiments, step (b) includes mixing the first mixture with at least 10% w/w of the fruit puree.

According to some embodiments, the process may further include adding a sweetener and/or flavoring agent at step (a) or (b). According to some embodiments, at least 15% w/w of sweetener is added, wherein the weight percent relates to the to the total weight of the final product. According to some embodiments, at least 0.1% flavoring agent may be added in addition to or instead of the sweetener.

According to some embodiments, the second mixture may be casted into a mold prior to the freeze drying.

According to some embodiments, the second mixture is frozen and shaped prior to freeze drying.

According to some embodiments, there is provided a method for administering a nutraceutical to a subject in need thereof, the method comprising inserting into the subject's mouth, the herein disclosed nutraceutical composition.

According to some embodiments, the subject is a subject undergoing or having undergone bariatric surgery.

The following examples are presented in order to more fully illustrate some embodiments of the invention. They should in no way be construed, however, as limiting the broad scope of the invention. One skilled in the art can readily devise many variations and modifications of the principles disclosed herein without departing from the scope of the invention.

### EXAMPLES

### Example 1: Process for the Preparation of a Nutraceutical Composition Comprising Multivitamin

The ingredients of the composition are set forth in Table 1 below.

TABLE 1

| Raw Materials | Weight (g) | Percent Weight |
|---|---|---|
| Fruit Puree | 28.2 | 28% |
| White sugar | 25.4 | 25% |
| Lemon salt | 2.3 | 2% |
| Coconut oil | 25.4 | 25% |
| Multivitamin | 18.6 | 19% |
| Total 1 Pack | 100 gm | 100% |

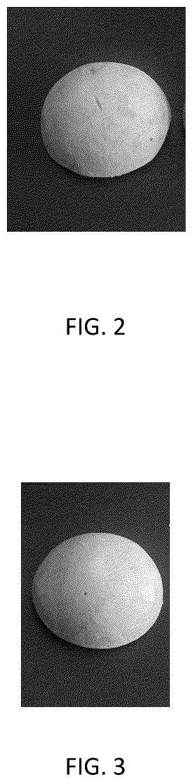

Initially, the multivitamin (a combination of vitamins and minerals, including, Calcium, Copper, Iron, Zinc, Vitamin B6, Folic Acid, Vitamin B1, Vitamin C, Vitamin A, Vitamin E) was mixed into the coconut oil until fully dissolved. The multivitamin—coconut oil mixture (first mixture) was then mixed with the remaining ingredients to produce a mash-like mixture (second mixture). The mash-like mixture was poured into IQF machine (individual quick freezing), moulds or by depository system, frozen, and subsequently lyophilized until the total amount of water was below 3%, so as to obtain an essentially solid, yet meltable single-dose composition. An exemplary pictogram of the obtained product is shown in FIG. 2.

### Example 2: Process for the Preparation of the Herein Disclosed Nutraceutical Composition Comprising CBD

The ingredients of the composition are set forth in Table 2 below.

TABLE 2

| Raw Materials | Weight (g) | Percent Weight |
|---|---|---|
| Fruit Puree | 52.4 | 52.4% |
| White sugar | 26.2 | 26.2% |
| Coconut oil | 20.1 | 20.1% |
| CBD | 0.78 | 0.78% |
| Total 1 Pack | 100 gm | 100% |

Initially, the CBD was mixed into the coconut oil until fully dissolved (to obtain a first mixture). The CBD— coconut oil mixture was then mixed with the remaining ingredients to obtain a mash-like mixture (second mixture). The mash-like mixture was poured into moulds, frozen, and subsequently lyophilized until the total amount of water was below 3% so as to obtain an essentially solid, yet meltable single-dose composition. An exemplary pictogram of the obtained product is shown in FIG. 3.

### Example 3: Evaluation of the Nutritional Value of the Herein Disclosed Nutraceutical Composition Comprising Multivitamin

The nutritional value of the freeze-dried single dose composition including a mixture of multivitamin was verified by suitable analysis methods (HPLC (for vitamins B6, B9, B1, C, A, E, D3) and ELISA (for vitamin B12). The amount (weight pre dose) of the listed vitamins/minerals (of the multivitamin mixture) was determined prior to mixing with other ingredients, and in the final product (after freeze drying). The results are presented in Table 3. The results clearly demonstrate that the nutritional value of the exogenous multivitamins has essentially remained the same, and that the process for manufacturing the freeze dried product does not harm the nutritional value of the exogenous multivitamins. The results show that the freeze dried nutraceutical composition can indeed maintain the nutritional value of the exogenous nutraceuticals included therein, and further substantiate the advantages of the freeze dried nutraceutical composition.

TABLE 3

| | | |
|---|---|---|
| | | Weight per dose in |
| Exogenous | Weight per dose in | the freeze dried |
| Nutraceutical | the original premix | final product |

| | | | | |
|---|---|---|---|---|
| Calcium | 592 | mg | 593 | mg |
| Copper | 1.73 | mg | 2.16 | mg |
| Iron | 30.1 | mg | 32.6 | mg |
| Zinc | 30.4 | mg | 38 | mg |
| Vitamin B6 | 17.2 | mg | 16.8 | mg |
| Folic Acid | 0.585 | mg | 0.675 | mg |
| Vitamin B1 | 2.37 | mg | 3.47 | mg |
| Vitamin C | 134 | mg | 181 | mg |
| Vitamin A | 2.7 | mg | 3.1 | mg |
| Vitamin E | 296 | mg | 310 | mg |

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

1.-33. (canceled)

34. A freeze-dried nutraceutical composition comprising a mixture of:
(a) at least 10% w/w of a fruit puree and/or a vegetable puree;
(b) at least 5% w/w of an edible oil; and
(c) at least 0.05% w/w of an exogenous nutraceutical;
wherein the nutraceutical composition is freeze dried to obtain a ready to be consumed product form which melts in the mouth.

35. The composition of claim 34, comprising less than 5% w/w water.

36. The composition of claim 34, comprising at least 5% w/w of the exogenous nutraceutical.

37. The composition of claim 36, comprising 10.5%-40% w/w of the exogenous nutraceutical.

38. The composition of claim 34, wherein the exogenous nutraceutical is a vitamin, a mineral, an herb, an herb extract, an herb derivative, a fungus, or any combination thereof.

39. The composition of claim 38, wherein the exogenous nutraceutical is a multivitamin.

40. The composition of claim 38, wherein the nutraceutical comprises CBD and/or THC.

41. The composition of claim 34, comprising 15%-70% w/w of the fruit puree and/or vegetable puree.

42. The composition of claim 34, comprising 10%-40% w/w of the edible oil.

43. The composition of claim 34, wherein the edible oil is an oil having a melting temperature of below about 40° C.

44. The composition of claim 36, wherein the edible oil is selected from a vegetable oil, a saturated fatty acid, unsaturated fatty acid, or any combinations thereof.

45. The composition of claim 44, wherein the edible oil is coconut oil.

46. The composition of claim 34, further comprising a flavoring agent and/or a sweetener.

47. The composition of claim 46, comprising 20%-40% w/w of the sweetener.

48. The composition of claim 34, comprising about 1%-5% of water.

49. A process for the preparation of a freeze-dried nutraceutical composition, the process comprising the steps of:
a. mixing an exogenous nutraceutical with an edible oil to obtain a first mixture, wherein the mixing us performed at a temperature of below 50° C.;
b. mixing the first mixture with a fruit puree and/or a vegetable puree to obtain a second mixture;
c. freeze drying said second mixture until water content is less than about 5% w/w of the product; thereby producing a freeze-dried nutraceutical composition having a ready to be consumed product form, which melts in the mouth.

50. The process of claim 49, wherein step (a) comprises mixing at least 5% w/w of the final product of the nutraceutical with at least 5% w/w of the final product of the edible oil.

51. The process of claim 49, further comprising adding a flavoring agent and/or a sweetener at step (b).

52. The process of claim 51, wherein the second mixture is casted into a mold, frozen and shaped prior to the freeze drying.
